(19) United States
(12) Patent Application Publication
(10) Pub. No.: US 2013/0309645 A1
(43) Pub. Date: Nov. 21, 2013

(54) Systems and Methods for Educational Social Networking

(71) Applicant: The Trustees of Columbia University in the City of New York, New York, NY (US)

(72) Inventor: Simon Billinge, Brooklyn, NY (US)

(73) Assignee: The Trustees of Columbia University in the City of New York, New York, NY (US)

(21) Appl. No.: 13/833,563

(22) Filed: Mar. 15, 2013

Related U.S. Application Data
(60) Provisional application No. 61/611,710, filed on Mar. 16, 2012.

(51) Int. Cl. G09B 7/00

(52) U.S. Cl. CPC G09B 7/00
USPC 434/350

(57) ABSTRACT

A peer instruction network comprising a scalable, web-based university combining peer instruction, social networking technologies and conventional university courses to provide a rich and scalable learning platform for a virtual university of the 21st century.

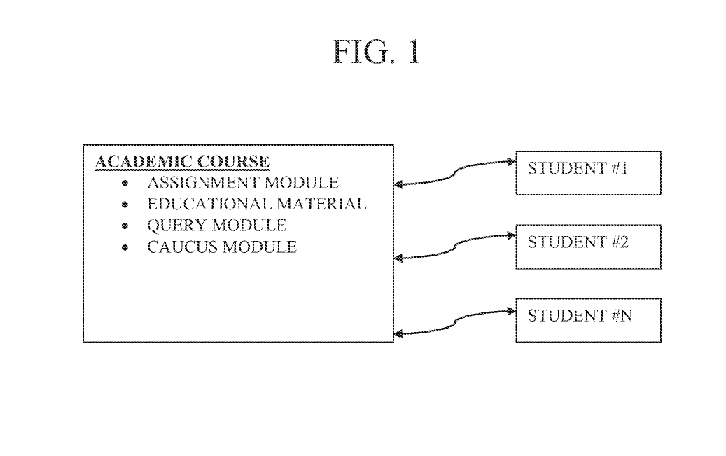

### RELATED APPLICATION

This application claims priority to U.S. Provisional Patent Application Ser. No. 61/611,710 filed Mar. 16, 2012, the content of which is hereby incorporated herein in its entirety.

### BACKGROUND OF THE DISCLOSED SUBJECT MATTER

### Field

The disclosed subject matter is a scalable method and device implementing social networking computer platforms to provide Peer Instruction education to a broad audience. The scalability is particularly important to science teachers in the K-12 sector where they may not be scientifically trained or have advanced science degrees, and consequently may not be well placed to encourage or facilitate in-depth scientific student discussion.

### SUMMARY OF THE DISCLOSED SUBJECT MATTER

The presently disclosed subject matter provides systems and methods for utilizing social networking methodologies to implement and improve peer instruction in a scalable online context. Education consists of both the acquisition of knowledge and the developing of understanding. Knowledge in the form of information can be obtained by reading and listening to lectures and memorization. However, turning knowledge into understanding is the key to successful learning. Teaching is often done in the form of lectures but the effectiveness of this approach is being questioned by education research.

The Peer Instruction approach is much more effective at producing understanding of conceptual material than is the traditional lecture format. There is a huge amount of factual information already in existence on the web, either for free or fee. For example:
(a) Some universities are putting thousands of high quality lectures online, free to view;
(b) Wikipedia® contains millions of pages of high quality content knowledge; and
(c) Many traditional textbooks have online versions or ebook versions available online.
   Social networking and remote web-based communication is now at its most powerful ever, both in terms of capabilities and the powerful outcomes that it produces, even to the point of precipitating revolutions

In accordance with the present subject matter, the question is how the peer instruction approach, factual information on the web, and social networking and other remote web-based communication may be combined into a powerful online learning community, a virtual university for everyone, a world classroom, and/or a “Learnbook” instead of Facebook®. The subject matter described herein provides systems and methods to implement a virtual university, world classroom and/or “Learnboook.”

### DETAILED DESCRIPTION

In accordance with the subject matter described herein, a social networking platform is provided for interactive educational social networking. In one aspect, a “cork” or an electronic peer instruction module, as further described below, is provided for educators and students to create a new method for online learning.

Beginning in the early 1990's Physics Education research began to quantify students' knowledge of key concepts in mechanics and later electricity and magnetism in introductory physics courses at the college level. A series of multiple choice questions were developed called the “force concept inventory” (FCI) that challenged the students' understanding of the key concepts underlying the material. The questions are significantly different from the more traditional “plug and chug” questions where a student had to remember an equation, and figure out how to plug in numbers and evaluate the answer. Researchers found that students had a hard time getting these questions right even right after completing an introductory physics course. In essence the course had failed. In more detailed studies the test was given at the beginning of the course and at the end of the course to see how much was learned. The results were dramatic and alarming. Very little at all was learned. Peer Instruction is a method that seeks to remedy this problem.

Peer Instruction can involve:
students having a reading assignment and reading a chapter or sections from a textbook before class;
in class, instead of a traditional lecture which is usually a rehash of the textbook, the instructor presents a question with multiple-choice answers, similar to the FCI questions, that test one of the concepts in the reading;
students attempt to answer the question. The instructor collects statistics (i.e., how many people responded to each possible answer);
students discuss their answer with their neighbors, or in small groups, explaining why they chose the answer they did to their colleagues.
after a fixed time of discussion, the instructor asks the question again and requests every student to make a new response;
depending on the outcome of the question/response the instructor selects the next question. If the class is having trouble with the concept he may choose another question that tests the same concept. If the class understands the concept he may move on to the next concept;
if necessary the instructor may lead a discussion himself to resolve misconceptions.

### Social Networking

Facebook® is the canonical social networking site which has revolutionized how we interact on a fundamental level. People are given a platform where they can create circles of friends and share thoughts, eavesdrop on other friends, and show their appreciation for (“like”) others' ideas. The website also has different ways to interact one-on-one (chat or send messages) or in small groups (group chat). The amount of functionality that the website offers is surprisingly little, but what people do with it is incredible.

Wikipedia® is in another sense a hugely successful social networking experiment. Again, in this case, you provide a platform, again with rather limited functionality, where people can contribute knowledge and make it open to the world. In this case, the contributions are largely factual knowledge that has persistence and grows into a massive online encyclopedia. The challenge here is to ensure that the content is accurate, since anyone can write anything on there and it can be wrong or right. The reason that it works is that anyone can edit pages as well as write them, so when something incorrect is written, another person can spot the problem and make a correction. The web-site is built on versioning software so every version is retained and if an incorrect edit is made, or a malicious or accidental deletion (or “vandalism” edits) occurs, the article is quickly and easily restored to its prior version. After a few adjustments to things such as permissions and authentication of authors, the right balance of openness to everyone but accountability of what is written has been established and Wikipedia® is becoming a de facto repository of the world's knowledge.

There are a number of factors that can be put together in different embodiments. In one embodiment, peer instruction is combined with social networking In accordance with this embodiment, a social network platform is created similar to Facebook® or Google+®. An “instructor” creates a “course” that includes links to reading material or online lectures and a series of conceptual questions to test understanding of each reading assignment. Students log in and are authenticated. Students read the assignment then respond to the question by selecting a multiple-choice answer. At this point they may (or may not) be shown the distribution of responses from the “class.” Once they have clicked their response they are given access to a discussion room on the topic where through chat or broadcast (“wall”) posts or using voice over internet protocol (VOIP) style chat they discuss the concepts. After a fixed period of time in the chat room the questions are opened up again and the student can register a new response to the same question. The new “post-chat” results can be posted to see how the distribution of responses changed. The students move on to a new question. If evaluation is needed for the course then online tests can be administered.

In another embodiment, online Peer instruction courses can be created on the social networking platform. In one embodiment this would work like a traditional university course. Professors would make use of the platform as a virtual classroom, post their materials, post the questions, run the classes at pre-appointed times so the discussions are synchronous. In this embodiment the service could be made available on a fee basis. Depending on the agreement, the course materials and the student responses could be made available to the Professor, but may or may not be retained in the database, or anonymized versions may be retained in order to build up statistics on student responses.

In another embodiment the Professor selects content and/or questions from a database of content on the host server, either for free or for a fee which could be collected from the School of the Professor using the service, or from the students enrolled in the course. In another embodiment the questions are free write or involve mathematical manipulations and are not multiple choice. In another embodiment the content is provided by a publisher and made available to students for a fee. In another embodiment, students get points for right answers and build up a points tally. In another embodiment there are online exams that take place. In another embodiment the course is given asynchronously, where a student can do the work at their convenience, within time bounds that can be as tight or loose as desired. The person can either chat in real-time if another student is online at the same time (tools for facilitating this would be helpful so students can open up a particular questions together) or read a thread of stored discussions that have gone on previously. In another embodiment, access to the course materials are not confined to a small group of paying students enrolled in a particular course. In this case a student could take the course but not receive credit towards a degree or diploma. In another embodiment the service is used by corporations for training purposes. In another embodiment the service is used by elementary, middle and high schools. This will be more viable as schools increasingly move over to tablet based instruction, which is an emerging trend. In another embodiment an elementary, middle or high school teacher is in a classroom with students who are using the platform but expert discussion moderation is being provided remotely by a scientific specialist.

Create an open world wide classroom platform, Wikidemia perhaps, where individuals can create their own free online courses, or contribute their own questions, linking to online material, for example, Wikipedia®. It would be run on the same lines as Wikipedia® (content on versioning software platform, some auto-curation, users log in and abusers can be banned) and Facebook® (social networking tools) combined.

In another embodiment people could create groups of friends and arrange among themselves to work through courses together. The software could accommodate this by allowing a self identifying group logged in together to receive the questions synchronously. Someone who misses a group session would have the opportunity to catch up asynchronously, or in a makeup group, having access to the discussions of the other friends.

In another embodiment, some contributed course could be for fee. The funding model could be that contributors creating a for fee course pay for the service but can charge students to enroll, free users are subjected to advertising, or like Wikipedia® run through a nonprofit foundation.

In another embodiment contributors of free content receive virtual rewards, as in computer gaming, each time a student takes one of their questions or modules (a module would be a reading assignment and a series of questions).

In another embodiment, students receive virtual rewards each time they get a question right. If they retake the question they get no reward (other than the satisfaction of learning the right answer).

In another embodiment we separate the learning and the accreditation and we allow entities (schools, individuals, corporations) to use the platform to set and administer exams. This would be a for fee service. A challenge would be to eliminate cheating by a student logging in someone who is not themselves or by not working alone. I guess the online universities like University of Phoenix are dealing with this somehow. A business model may be to provide physical locations in different cities where people can go to take the exams.

In another embodiment the platform contains some intelligence so that the next question that appears from the database of questions depends on the response to the previous questions. A so-called recommender system.

In another embodiment the system collects statistics on usage and can sort questions based on usage.

In another embodiment the system allows users to rate questions and sorts questions based on recommendations.

In another embodiment, the system is linked to Wikipedia® so that, over time, all of the pages have peer instruction questions linked to them, provided by contributors.

In another embodiment, the system retains anonymized statistics on all responses and these data can be made available to researchers or to teachers for analysis.

In another embodiment non-anonymized responses are kept and patterns of performance of an individual can be analyzed for self-analysis, accreditation or other purposes and compared with different cohorts of anonymized results (top 90th percentile students, mean-score students and so on). In another embodiment this is done on a question by question basis.

In another embodiment questions are tagged by topic or by concept or type and the analysis of the student vs. various different cohorts is done by topic or concept or type.

### The Cork: The Electronic Peer Instuction Module

One key to the present subject matter is the electronic peer instruction module called the Cork. The workflow can include the following steps:
Reading assignment. It could also be to watch a lecture or a video (“the reading”).
Answer a multiple choice question based on the reading assignment (“the prior”).
Optionally, view the distribution of responses to the prior without, where relevant, the correct answer being revealed (“the preview”).
Discuss your answer with peers, exploring their answers and their reasoning (“the caucus”).
Re-answer the same question, either keeping the same answer or electing to change based on the discussion (“the posterior”).
View the distribution of responses to the posterior, alongside those of the prior with, where relevant, the correct answer being identified (“the review”).
Optionally, discuss and digest the outcome. Did the cluster of responses converge towards a single answer? In the case where there is a right and wrong answer, did they cluster towards the right answer? What were the common misconceptions in the prior? Do we understand them, are they resolved? What did we learn? (“the reflection”).
Start again with a new reading assignment where the choice of question/topic depends on the outcome of this one. If there is still confusion select another question that reveals insight on the same topic, if there is broad consensus, move to a new topic (“the transition”).

This aforementioned sequence of steps is a peer instruction module. An aspect of the current subject matter is to make an electronic peer instruction module using web and social networking concepts. An electronic peer instruction module is called a Cork. The Cork may be used according to the following steps:
1. The student is logged in to his/her account (preferably using OpenID) and courses available to them are accessible.
2. Optionally, the student has some demographic information in their profile, conforming to current industry standards.
3. The reading assignment in the Cork includes electronic links to online material or links to a reference to offline material. The student can browse the material by following the links. It is important that it is done in such a way that there is an easy way back . . . for example, the links open in a new tab or window.
4. The “:prior” is a question with multiple-choice answers. This is created by the teacher of the course using online tools. Alternatively, previously created questions will be kept in a database and shared. Teachers can make a course by selecting their preferred questions from the database. These can be ranked in various ways based on usage and user reviews and searchable, making the database easy to use. They should be created on a versioning software platform so they can be edited over time to remove errors but older versions can be recovered if necessary (the Wikipedia® model).
5. The student takes the quiz by selecting one of the answers using a radio button. It will be important to have software working on mobile devices such as iPhones® and android phones and tablets.
6. The question will be running on top of a database that captures the responses.
7. The preview is a chart showing the students response and a histogram of the other responses. The comparison histogram could be generated from responses in the data filtered in different ways. For example, it could be filtered to just show responses from the current class, all responses by anyone ever who has used that question, all responses over some limited time period, etc. This could be determined by the teacher of the course, or alternatively could be selected by the student as a choice. Alternatively (and this may be best) the preview would not show any comparison histogram but just keep a record of the answer chosen by the student.
8. The Caucus involves online chat, but may also involve other social networking tools. Responses will be saved into a database and can be shared according to existing social networking protocols, i.e., with individuals, friends, friends of friends or open depending on the situation. Historical responses from the database could also be made available as discussion threads. These could be sorted based on criteria such as number of “likes” (which could be called “corkers” from “it's a corker”, number of times viewed, user reviews so that the best discussion threads float to the top).
9. In an alternative embodiment the caucus could be done by voice using VOIP or cell-phone technologies. In this case, as the technology evolves, voice recognition software could be used to store the responses of the people. Preferably this would be done anonymously to protect privacy, though the discussion thread should be separated into “voice streams”. This will require tagging the voice connection. For example, a “taucus” or “torkus” to differentiate from the chat based “caucus” (or “corkus”).
10. In another embodiment a torkus may be used in a corporate meeting setting to record the discussions in a rich way. Attendees at the meeting, whether local or remote can connect through a Bluetooth device and their mobile phone and their comments are tagged to them and recorded in the meeting thread, as well as any prior or posterior votes. Corks will have to be created on the fly in this situation (we will call this “popping a question”). A comment in the thread could be later tagged as an action item and when someone accepts the action item, this could be tagged as an accept and action item and to-do lists automatically generated and sent to people by email, for example.
11. In a class-setting the discussions will be synchronous, and the caucus will be open for a fixed time period. There will also be a time window for selecting the posterior before it closes, with penalties for not responding before it closes to encourage participation.
12. In an alternative embodiment the caucus could be asynchronous so a student goes to the caucus at their convenience and chats with whoever is online at the time and interacts with the historical discussion threads. In the asynchronous mode, the caucus and posterior polling could still be time limited. Alternatively it could be open with no time limit.
13. In asynchronous mode students could “corral” around a particular question so that there would be a mechanism to call “friends” or classmates who are online to a particular cork.
14. The posterior will be the same question as the prior but the response will be tagged as a posterior response rather than a prior response for generating posts. In one embodiment, students are only allowed to vote once in the prior and once in the posterior.
15. In one embodiment, students can return to a cork and vote again. A complete history of their voting record is retained. However, only their most recent vote counts in the anonymized statistics used to generate the comparison charts. This is to avoid manipulation of the results by multiple voting.
16. In another embodiment the teacher can leave questions open for voting and revoting for a specified period of time then close the voting.
17. The review phase progresses much like the preview phase where histograms are shown of the results from the database of the prior and the results of posterior, for example, with the prior results on the left of the screen and the posterior results on the right of the screen. The vote of the students indicated and also, where applicable, the correct answer.
18. In one embodiment, there is a discussion phase accompanying the review where students can exclaim on the outcome and teacher can lead any discussion he/she desires to summarize what has been learned.
19. In one embodiment the review phase begins at the request of a teacher at a specified time, for example, after voting is complete for the whole class.
20. In another embodiment, review begins immediately after the student makes their vote, based on the results already received. An automatic screen refresh would allow the student to see the results updating in real time.
21. In one embodiment the chart updating in time could happen in a popup window that can be dedocked and left on the desktop. This would be a good feature for the person who created the cork and who wants to monitor activity.
22. In the transition phase the teacher selects and loads the next cork for the class.
23. In another embodiment, the teacher preselects a series of corks and the transition happens automatically.
24. In another embodiment, the next cork is selected by software from a list of corks preselected by the teacher based on the outcome of the previous cork(s) according to an algorithm that measures collective student performance.
25. In another embodiment, for example, when a student is using the software in asynchronous mode, the next cork is selected by software from a list of corks preselected by the teacher based on the outcome of the previous cork(s) according to an algorithm that measures individual student performance.
26. In another embodiment, students can choose to reject a cork selected either by the teacher or by software and ask for a new one to be selected. This is more relevant for asynchronous mode.
27. In another embodiment, the student can select a new cork from lists recommended by software, by other users, by a teacher or by another method, or the student can browse for or search for a cork from a database of corks.
28. In the review stage, the students are given the opportunity to “like” the cork, or give a star-rating to the cork.
29. In another embodiment the students could write a review of the cork.

### Popping the Question: Creating the Cork

Some businesses provide a website for others to place their content, similar to Wikipedia® and Facebook®. In particular, most content may be external in the form of written articles, videos on Youtube® or on a university distance learning website, news articles or links to ebooks or references to books.

In one aspect of the disclosed subject matter, a virtual classroom is provided in which a teacher or a content expert, such as a book author, creates the cork , a teacher or some other authority pops the cork, and students pull corks.

Creating corks: Generally, the teacher or content expert creates the cork through a browser. In this manner, easy to use online tools are provided for creating corks. The “cork” button can be among the “share” buttons associated with (pretty much all) online content these days. Currently, share buttons include facebook, google+, pinterest, tunmblr and the like. When a person actuates the “corkus” share button, a sign-in interface is provided for security purposes. If not already a member, then a form will appear which links to an article but where it will be easy to create a question and a number of multiple choice answers. These will be saved, along with metadata such as the author information and author supplied tags, date and time, etc. Another tool works in reverse. A cork creator will be presented a form to create a cork and can browse for a URL to link to. Similarly, a creator could copy an existing cork and adapt it.

On the website the teacher will set up accounts, log ins, and create courses by making corks and having them link to the external material. A Corse is course of learning that consists of a series of corks as described above. The teacher will create the Corse by selecting existing corks from a database or by creating his/her own Cork. In one embodiment the Cork is selected from the teacher's own database of corks. In another embodiment, the Cork is selected from an open database of corks supplied by other users under some kind of open creative commons copyright. In another embodiment the Cork is selected from a database of proprietary corks supplied by other entities where the teacher has paid for a subscription. In another embodiment the Cork is selected from a database of proprietary corks supplied by other entities which is paid for at use-time when a student enrolls in the course. This is the current textbook model whereby the students pay for the required textbook after they enroll in the course. In one embodiment the teacher selects parameters for the course such as time limits for Cork uses and voting and so on as described above. The teacher uses software tools for ordering the Corks. If transitions are controlled by outcomes there will be conditional side branches to the Cork tree and these must be sequenced too.

Corks may be edited to bring the up to date or to add questions. If it is a third-party Cork, depending on the license on the Cork the edited version can be saved to the new owners' database provided the license conditions are met. New Corks are created using a simple GUI interface that allows links to be made, questions to be typed, including special characters, images, videos and support for mathematical formulas. Between, for example, 3 and 5 answers can be proposed and, where appropriate, the correct answer is tagged.

In another embodiment the answers can be true/false answers. In another embodiment there can be more than one true/false answer and the allowed answers are permutations of these true/false statements. For example: Is it cold outside? T/F Is it raining outside? T/F the possible answers are TT, TF, FT, FF. In this embodiment, to make it easier for the user they don't select the permutations, they just answer both T/F question but the software makes histogram of all the combinations. This type of question can be very powerful if you gang together multiple T/F questions.

In another embodiment the T/F type of question could be something other than T/F but organized like a T/F question for example, High/Low, Left/right, and it need not be binary, for example, left/right/center. Combinatorics may grow quickly so in some embodiments there may be limits on the number of permutations in a question like this.

### Databases of Corks

The Corks are important and valuable content. They are maintained in searchable databases and written using versioning software so that there is a complete history of changes. In some embodiments they are stored as plain text with markup (though not necessarily written as such).

Tools are available for the teacher to make her/his database of Corks available to others for free (for example, with some kind of creative commons license) or for fee. In another embodiment a third-party Cork that has been edited can be saved and made available for fee by the editor, but part of that fee will go to the originator or originators. In some embodiments, the website charges commission on all for fee transactions. Depending on the Cork license it should be possible for people to edit the Cork and save it back to the original database to correct errors. The Cork database is run on a versioning system so that bad edits can be reversed or earlier versions recaptured for some reason. In some embodiments a commit comment is required. In another embodiment, teachers can report suspected errors to the originator by posting a comment associated with the cork.

In one embodiment there will also be a discussion thread associated with a Cork that is not visible to students taking the Cork. This could contain the solution (which is different from the right answer because it explains why it is right). This would be a spoiler if it was made available to students taking the test) and discussion about whether edits are needed or why edits were carried out.

In general the databases are searchable. Additionally, in some embodiments, recommender software is included. In one embodiment, software would search the links to external material and make suggestions of new corks that link to the same material. In another embodiment the text of the cork can be searched and other Corks recommended based on similarity. In another embodiment, the author gives the Cork tags and these are used to make recommendations. In another embodiment, a teacher who is not an author gives the Cork tags. Ranking of Corks can also use data such as number of times used in a course, number of times taken by students, number of Corkers (“likes”), average number of user assigned stars, etc.

Content providers such as textbook manufacturers are welcome in such an environment and may welcome this as they may avoid bringing out expensive new editions since there will be no second-hand book market if the funds flow through student enrollment in the course.

Popping corks: Thus, the system and method provides tools to create a “corse”. The creator of the “corse” whether it is a teacher or other content expert may pick different kinds of access such as open, free with registration, for fee. The instructor may select corks from a database. Powerful tools for searching for and selecting corks will be provided based on relevance, cork ranking algorithms based on popularity and effectiveness, tags and so on. This is the heart of the system as high-school teachers for example, can easily select corks that present the current best practice for their classrooms. As an incentive to contribute content, cork creators may earn points or money if their corks are reused, depending on the license.

### Databases of Responses

A key aspect of the present subject matter is the database of student responses. They are valuable to the student to gauge their progress and to the teacher to evaluate student progress. They will also be valuable potentially to education researchers and cognitive psychologists interested in learning and intelligence. In the long run, they may also be valuable to historians. By looking at the time evolution of responses, especially to opinion-based questions rather than questions with a single “right” answer, trends in thought and opinion can be plotted over time.

Pulling a cork: Normally, students enrolled in a corse which may be free, or for fee. The students can follow the corse laid out by the instructor either for credit or not depending on how the corse has been set up. The corse may be taken synchronously or asynchronously with responses made on portable devices, ipads and computers through a browser. For example: the corse can take the form of many modes:

In a live (in classroom) where the instructor is using the cork database for his/her corks, and students can respond from mobile devices. This will work well in schools when courseware is handed out on tablets, which is an emerging trend in education today.

Online synchronous scales up the classroom experience to a live but online experience. Instructors will open up corks for consideration and the distributed class will be logged on and respond through a browser or mobile device but all at the same time. We will offer the ability to chat in small groups assigned either randomly, or requested groups of friends or assigned by the instructor or other methods.

In online asynchronous students enrolled in a corse can log in in their own time and take the prescribed corks as they wish. Comments and chat are archived. If others are logged on at the same time the ability to corral around a particular cork is provided. Students can also interact with archived chats of other students.

Floating corks can be created in which users can create and pop individually, without being enrolled or part of a corse. For example, in a “comments” section following a news article or some other knowledge medium but more fun and thought provoking than regular commentary sections.

### Applications Outside the Education Domain

Since questions can be asked that get at people's opinions rather than having a correct answer, in some embodiments, the present subject matter may be used for market research and for corporations to gauge emerging trends in their markets. One model is to license market research and companies to use the platform and the invention for their research. However, a much more exciting possibility is to create a free to use social networking website along the lines of Facebook®.

### Corkus.com: A Social Networking Site

The way to think about this is the following: Facebook® taught us how to chat, corkus gives us things to talk about. The basic idea is the following: There are now no “teachers” and “students” but just users. The users can “pop” questions on any topic at any time, linking to any material they like. They can maintain groups of friends who they chat to, but the chatting takes place in the context of a Cork, so they are chatting “about” something. It can be silly, random, about TV or serious about politics. The questions could range from “Should Justin Bieber get a haircut?” to “Will an oil pipeline from Canada to Texas destroy the earth through global warming?” and the answers straight or funny. People can corral friends to a question they have popped or simply stumbled across on the website. In some embodiments site membership would be free and as widespread as possible, as with Facebook®. In other embodiments, statistics are kept of how many people take a Cork by answering the question (when people take a cork we call it “pulling a cork”) and a user's statistics are maintained, so they can see how many corks they popped (made) and how many pulls each Cork got (how many people answered it), as well as how many Corks they pulled. This has shown to be highly motivating.

In some embodiments, recommender software selects from a database new Corks to take after the current one is pulled based on criteria such as relevance (for example, other Corks that link to the same material) and usage statistic as described above. In another embodiment, Corks can be aggregated based on various similarity criteria. Again, using links it will be possible to increase connectivity. For example if a Cork links to one source and another Cork links to that source but also to a second source, it is likely that the first Cork should also link to the second source. In this way, Corkus becomes a powerful aggregator of the world's news, with the news that is of the greatest interest to people floating to the top. In another embodiment, Corkus could offer a web service such that content originator sites such as news sites could link their “comments” or “discussion” forums to Corkus to make them more interesting than the dull and mean-spirited drivel that one finds in most of those discussion sections. The added advantage would also be that it brings more visitors to the news site from the Corkus side because someone on Corkus who hadn't read that article but found that Cork may go to the article, so it increases traffic in the other direction.

On an altruistic level this could increase our international understanding in the following way. Instead of having to learn a new language to communicate with people from other countries, Corks could be translated to other languages and respondents take the same set of questions in their own language. So discussions are happening and the same questions are being answered on the same topic but in the local language. The results could then be combined to see how different the responses were in different cultures. These could be posted and new questions could be formulated that ask questions to probe the differences. Instead of learning a language to increase international communication, it will increase international communication in people's native language.

Many online discussions are depressingly negative. Indeed, much of today's political and social dialog is this way, with everyone putting everyone else down. To keep the discourse at a higher, more positive, level each post could have an “upper” and a “downer” button. If the comment is fundamentally negative a reader would click the downer button, and vice versa for a fundamentally positive statement. Upper and downer data would be collected for each user and could be seen by the user (but probably not others) giving them a “glass half full or half empty” or positivity index. There will be a subtle tendency for people to hold back on their negative statements to keep their positivity index up.

In another embodiment downers and uppers would be assigned algorithmically by the software based on an analysis of the words in the discussion posting.

In general the business model is based on advertising based revenue. However, one of the key developments of this technology is that user's opinions are captured as responses to multiple choice questions, which makes the data more usable than just typed comments. It is immediately possible to make histograms of responses, and plot the results through time as a history, watching trends and opinions change with time. The number of Corks popped and pulled on particular issues will give data on people's interest in various topics, and the links to sources will make it easier to sort by topic, though keywords could be used too for this. This information would be very valuable to corporations and investors and could be made available for a fee. People could also buy the time-series results for particular Corks, either ones that they created or others', for market research. They could also bundle results, for example, all the Corks that link to a particular news article or cluster of news articles, to get a larger sample, and this could be provided for a fee.

In some embodiments corks are offered as an online service to embed in third-party web-pages, for example, similar to how advertisements and YouTube® videos are embedded in web pages. This mode would aid many types of organizations. For example, a news website may wish to provide a discussion/comment thread related to a news article using corks instead of a standard format. Such embedding would permit the organization to have the corks appear in their web-page and would allow the reader to utilize the corks without the reader being directed away from the site. The embedding could be offered as a for-fee, or free, service.

While the disclosed subject matter is described herein in terms of certain embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

The disclosed subject matter is also directed to other embodiments having any other possible combination of the features disclosed above. As such, the particular features disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A scalable peer instruction networking system comprising:
a remote web-based communication platform accessible to a plurality of students, and
a web based academic course, accessible to the plurality of students, wherein the web based academic course includes
an assignment module including a plurality of assignments,
one or more electronic links to educational material,
a query module including one or more questions relating to the assignments of the assignment module, and
a caucus module configured to permit the plurality of students to confer with each other, and
an interface to permit the plurality of students to view the assignments, links to the educational material and the one or more questions.

2. The scalable peer instruction networking system further comprising:
a response module adapted to at least temporarily save responses to the one or more questions relating to the assignments, wherein the responses to the one or more questions are viewable to the plurality of students through the interface.
